(19) United States
(12) Patent Application Publication
(10) Pub. No.: US 2005/0231675 A1
(43) Pub. Date: Oct. 20, 2005

(54) In-plane switching liquid crystal display with shielded data lines

(75) Inventors: Chueh-Ju Chen, Miao-Li (TW); Chiu-Lien Yang, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/109,302

(22) Filed: Apr. 18, 2005

(30) Foreign Application Priority Data
Apr. 16, 2004 (TW) 93110625

(51) Int. Cl. G02F 1/1343

(52) U.S. Cl. 349/141

(57) ABSTRACT

An in-plane switching mode liquid crystal display (2) includes a first substrate (21), a second substrate (22), and liquid crystal molecules (60) interposed between the first and second substrates. A number of data lines (222) are arranged on the second substrate. An insulation layer (223) is arranged on the data lines. A number of common electrodes (26) are arranged on the insulation layer. The data lines are substantially covered and shielded by some of the common electrodes. Accordingly, the in-plane switching mode liquid crystal display has an improved display effect compared to the conventional art.

### BACKGROUND OF THE INVENTION

1. Field of the Invention

The present invention relates to liquid crystal displays (LCDs), and more particularly to in-plane switching liquid crystal displays.

2. General Background

LCD panels are generally categorized into a plurality of types according to the mode in which the liquid crystals thereof are driven. One kind of LCD panel has the liquid crystals driven by a perpendicular electric field. An example of this kind of LCD panel is the TN-mode (Twisted Nematic-mode) LCD panel. In this kind of LCD panel, the orientations of the directors (long axes) of the liquid crystal (LC) molecules are changed by application of an electric field which is normal to the substrate surfaces of the LCD panel. Thus transmittance of light passing through the LCD panel is controlled, for displaying images on the corresponding display panel. However, this kind of LCD panel has the drawback of a narrow viewing angle, which limits the types of applications available for the LCD panel.

On the other hand, another kind of LCD panel known as an in-plane switching (IPS) mode LCD panel has a wider viewing angle. In the IPS LCD panel, directors of the LC molecules are initially oriented in a direction parallel to a substrate surface. When a lateral (in-plane) electric field is applied to the LC molecules, they are rotated in a plane parallel to the substrate surface, whereby light transmittance through the IPS LCD panel is controlled. In order to generate the lateral electric field, it is normally necessary to arrange the common electrodes and pixel electrodes on a same substrate. Because the common and pixel electrodes are arranged on the same substrate, the number of electrodes and metal lines on the substrate is increased. This reduces an aperture ratio of the IPS LCD panel.

To solve the problem of the reduced aperture ratio of the IPS LCD panel, a technique known as super high aperture ratio (SHA) has been practiced by the Sharp Company. In an IPS LCD panel adopting SHA, an insulation layer is arranged on the data lines, and lines of thin film transistors (TFTs) that are formed on the insulation layer overlap the data lines. Therefore areas occupied by electrodes and metal lines on the substrate are reduced. Thus, the IPS LCD panel adopting SHA has a higher aperture ratio.

In a typical IPS LCD panel adopting SHA, metal lines of TFTs and data lines are made of tantalum (Ta). However, the electrical resistance of Ta is high. Therefore the width of the lines made of Ta needs to be increased, in order to reduce a load of the IPS LCD panel. Thus the Sharp Company developed SHA and practiced a new technique known as ultra high aperture ratio (UHA). In the technique of UHA, a material of metal lines of TFTs and data lines is aluminum (Al) instead of Ta. Because the electrical resistance of Al is less than that of Ta, the width of the lines made of Al can be reduced, thereby increasing the aperture ratio of the IPS LCD panel.

Referring to FIGS. 4 and 5, a conventional UHA IPS LCD is disclosed in China patent application CN 02148009 published on May 28, 2003. The UHA IPS LCD 1 includes a first substrate 11, a second substrate 12 opposite to the first substrate 11, and a layer of liquid crystal molecules 13 sandwiched between the first substrate 11 and the second substrate 12.

A first polarizer 110 and a transparent conductive layer 111 are arranged on an outer surface of the first substrate 11, in that order from top to bottom. A black matrix 112, a color filter 113, a transparent covering layer 114 and a first orientation layer 115 are arranged on an inner surface of the first substrate 11, in that order from top to bottom. The color filter 113 defines a plurality of gaps, and the black matrix 112 is arranged in the gaps. The first orientation layer 115 is adjacent to the layer of liquid crystal molecules 13.

A second polarizer 120 and a first insulation layer 121 are separately arranged on two opposite bottom and top surfaces of the second substrate 12 respectively. Data lines 122, a pixel auxiliary electrode 124 and a second insulation layer 123 are arranged on the first insulation layer 121, with the second insulation layer 123 covering the data lines 122 and the pixel auxiliary electrode 124. Common electrodes 16, pixel electrodes 17 and a second orientation layer 125 are arranged on the second insulation layer 123. The second orientation layer 125 covers the common electrodes 16 and the pixel electrodes 17, and is adjacent to the layer of liquid crystal molecules 13. The common electrodes 16 and the pixel electrodes 17 are made of a transparent electrically conductive material.

As shown in FIG. 5, when the UHA IPS LCD 1 is in an on state, an electrical signal passes through the data lines 122. The data lines 122 produce an electric field 128 influencing the directions of rotation of liquid crystal molecules 13 near the data lines 122. Thus, the display effect of the UHA IPS LCD 1 is liable to be corrupted.

To minimize this problem, as shown, some of the common electrodes 16 are configured to overlap the data lines 122, thereby shielding the data lines 122. However, a width of these common electrodes 16 is substantially the same as that of the data lines 122, and the common electrodes 16 are spaced a distance from the data lines 122 by the second insulation layer 123. Therefore the common electrodes 16 cannot adequately cover and shield the data lines 122. As seen in FIG. 5, when the electrical signal passes through the left-hand data line 122 (for example), the electric field 128 can still penetrate through parts of the second orientation layer 125 and influence the rotation directions of some liquid crystal molecules 13 near the left-hand data line 122.

It is desired to provide an IPS LCD which overcomes the above-described problems.

### SUMMARY

In one embodiment herein, an in-plane switching mode liquid crystal display comprises a first substrate and a second substrate, and liquid crystal molecules interposed between the first and second substrates. A plurality of data lines arranged on the second substrate. An insulation layer arranged on the data lines. A plurality of common electrodes arranged on the insulation layer, and some or all of the common electrodes substantially covering the data lines.

Because of the common electrodes substantially covering the data lines, when the data lines are on state, the common electrodes may completely shield an electric field produced by the data lines. Thus, molecules nearby the data lines are not be influenced by the data lines. Accordingly, the display effect of the in-plane switching mode liquid crystal display according to the present invention is improved.

Other objects, advantages, and novel features will become more apparent from the following detailed description of embodiments when taken in conjunction with the accompanying drawings, in which:

### BRIEF DESCRIPTION OF THE DRAWINGS

FIG. 1 is a schematic, side cross-sectional view of part of an IPS LCD according to a first embodiment of the present invention;

FIG. 2 is a schematic, side cross-sectional view of part of an IPS LCD according to a second embodiment of the present invention;

FIG. 3 is a schematic, side cross-sectional view of part of an IPS LCD according to a third embodiment of the present invention;

FIG. 4 is a schematic, top plan view of part of a conventional IPS LCD; and

FIG. 5 is a schematic, side cross-sectional view of the same conventional IPS LCD of FIG. 4, corresponding to line V-V thereof.

### DETAILED DESCRIPTION OF THE PREFERRED EMBODIMENTS

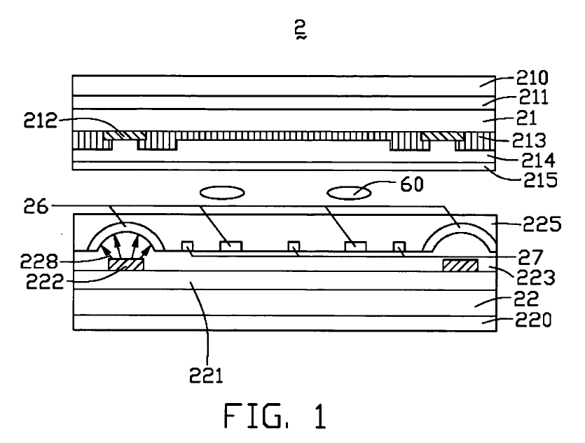

Referring to FIG. 1, an IPS LCD 2 according to a first embodiment of the present invention comprises a first substrate 21, a second substrate 22, and a layer of liquid crystal molecules 60 interposed between the first and second substrates 21, 22.

A first polarizer 210 and a transparent conductive layer 211 are arranged on an outer surface of the first substrate 21, in that order from top to bottom. A black matrix 212, a color filter 213, a transparent covering layer 214 and a first orientation layer 215 are arranged on an inner surface of the first substrate 21, in that order from top to bottom. The color filter 213 has a plurality of gaps, and the black matrix 212 is arranged in the gaps.

A second polarizer 220 and a first insulation layer 221 are separately arranged on two opposite bottom and top surfaces of the second substrate 22 respectively. Data lines 222 and a second insulation layer 223 are arranged on the first insulation layer 221. The second insulation layer 223 is for insulating the data lines 222 from the common electrodes 26. A second orientation layer 225, the common electrodes 26, and the pixel electrodes 27 are arranged on the second insulation layer 223, with the second orientation layer 225 covering the common electrodes 16 and the pixel electrodes 27 and being adjacent to the layer of liquid crystal molecules 60. The data lines 222 are covered directly overhead by some of the common electrodes 26 respectively, but with the second insulation layer 223 separating the data lines 222 and the common electrodes 26. The common electrodes 26 and the pixel electrodes 27 are made of indium tin oxide (ITO).

Each of the common electrodes 26 has an even thickness. A cross-section of each of the common electrodes 26 that overlies a data line 222 is arcuate-shaped, so that these common electrodes 26 can substantially cover the data lines 222. Therefore when an electrical signal passes through the data lines 222, an electric field 228 produced by the data lines 222 is substantially shielded by the common electrodes 26. Thus, the electric field 228 does not influence rotation directions of liquid crystal molecules 60 that are near the data lines 222. Accordingly, the IPS LCD 2 has an improved display effect compared to that of conventional IPS LCDs such as the IPS LCD 1.

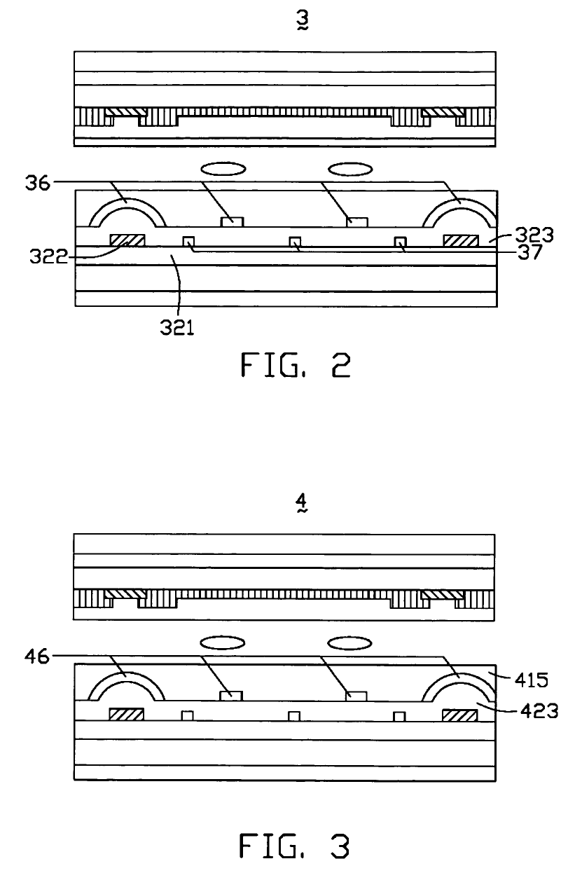

Referring to FIG. 2, an IPS LCD 3 according to a second embodiment of the present invention is similar to the IPS LCD 2 of the first embodiment. The notable differences and features of the IPS LCD 3 are as follows. Data lines 322, pixel electrodes 37, and a second insulation layer 323 are arranged on a first insulation layer 321, with the second insulation layer 323 covering the data lines 322 and the pixel electrodes 37. Common electrodes 36 are arranged on the second insulation layer 323.

A cross-section of each of the common electrodes 36 that overlies a data line 322 is arcuate-shaped, so these common electrodes 36 can substantially cover the data lines 322. Accordingly, the common electrodes 36 can substantially shield an electric field produced by the data lines 322. Thus, the electric field does not influence rotation directions of liquid crystal molecules that are near the data lines 322. The IPS LCD 3 has an improved display effect compared to that of conventional IPS LCDs such as the IPS LCD 1.

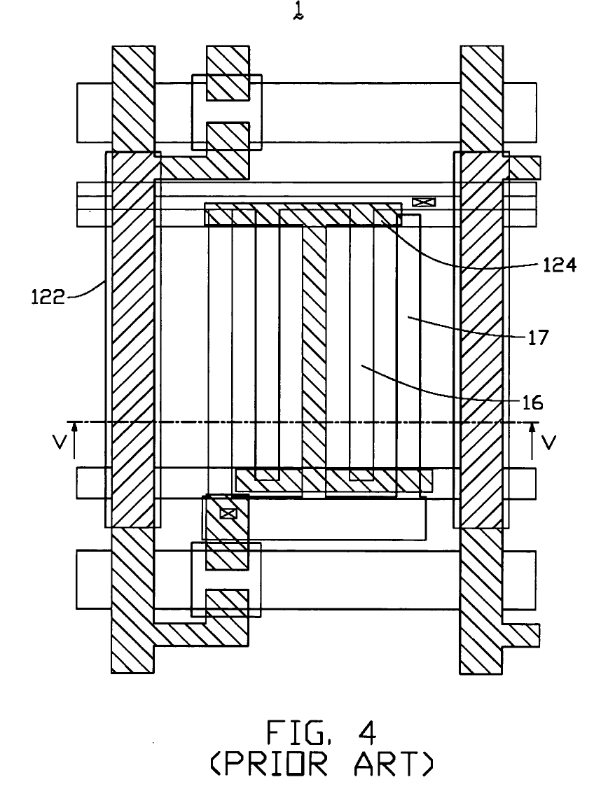

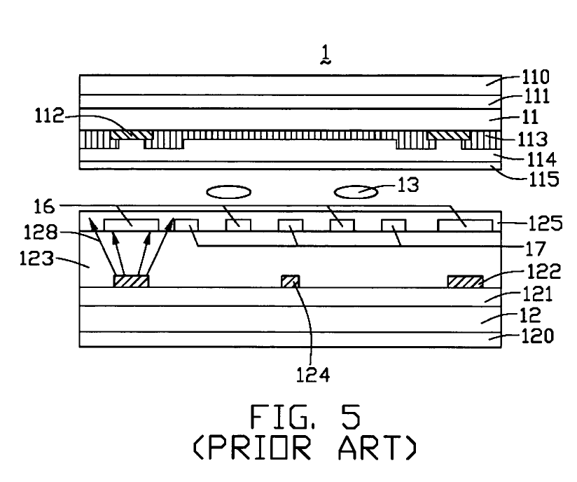

Referring to FIG. 3, an IPS LCD 4 according to a third embodiment of the present invention is similar to the IPS LCD 3 of the first embodiment. The notable different feature of the IPS LCD 4 is that it only has a single orientation layer, being a second orientation layer 415. The second orientation layer 415 is arranged on common electrodes 46 and a second insulation layer 423. Like the IPS LCDs 2 and 3, the IPS LCD 4 has an improved display effect compared to that of conventional IPS LCDs such as the IPS LCD 1.

The IPS LCD of the present invention is not limited to the above-described embodiments. For example, the common electrodes 26, 36 and 46 may be made of indium zinc oxide (IZO) or metal. The cross-section of each of the common electrodes 26, 36 and 46 may be an inverted “U” shape or an inverted “V” shape. Further, the common electrodes 26, 36 and 46 may have any other kind of cross-section, such that the common electrodes 26, 36 and 46 substantially cover the data lines and substantially shield the electric field produced by the data lines.

It is to be further understood that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. An in-plane switching mode liquid crystal display, comprising:
a first substrate and a second substrate, and liquid crystal molecules interposed between the first and second substrates;
a plurality of data lines arranged on the second substrate;
an insulation layer arranged on the data lines; and
a plurality of common electrodes arranged on the insulation layer, some or all of the common electrodes substantially covering the data lines.

2. The in-plane switching mode liquid crystal display of claim 1, wherein a cross-section of each of the common electrodes is a bent shape.

3. The in-plane switching mode liquid crystal display of claim 2, wherein a cross-section of each of the common electrodes is arcuate-shaped.

4. The in-plane switching mode liquid crystal display of claim 2, wherein a cross-section of each of the common electrodes is substantially an inverted “U” shape.

5. The in-plane switching mode liquid crystal display of claim 2, wherein a cross-section of each of the common electrodes is substantially an inverted “V” shape.

6. The in-plane switching mode liquid crystal display of claim 1, wherein each of the common electrodes has an even thickness.

7. The in-plane switching mode liquid crystal display of claim 1, wherein the common electrodes are made of transparent material.

8. The in-plane switching mode liquid crystal display of claim 7, wherein the common electrodes are made of indium tin oxide.

9. The in-plane switching mode liquid crystal display of claim 7, wherein the common electrodes are made of indium zinc oxide.

10. An in-plane switching mode liquid crystal display, comprising:
a first substrate and a second substrate, and liquid crystal molecules interposed between the first and second substrates;
a plurality of data lines arranged on the second substrate;
an insulation layer arranged on the data lines; and
a plurality of common electrodes arranged on the insulation layer, and some or all of the common electrodes substantially shielding electric fields produced by the data lines.

11. The in-plane switching mode liquid crystal display of claim 10, wherein a cross-section of each of the common electrodes is a bent shape.

12. The in-plane switching mode liquid crystal display of claim 11, wherein a cross-section of each of the common electrodes is arcuate-shaped.

13. The in-plane switching mode liquid crystal display of claim 11, wherein a cross-section of each of the common electrodes is substantially an inverted “U” shape.

14. The in-plane switching mode liquid crystal display of claim 11, wherein a cross-section of each the common electrodes is substantially an inverted “V” shape.

15. The in-plane switching mode liquid crystal display of claim 10, wherein each of the common electrodes has an even thickness.

16. The in-plane switching mode liquid crystal display of claim 10, wherein the common electrodes are made of transparent material.

17. The in-plane switching mode liquid crystal display of claim 16, wherein the common electrodes are made of indium tin oxide.

18. The in-plane switching mode liquid crystal display of claim 16, wherein the common electrodes are made of indium zinc oxide.

19. An in-plane switching mode liquid crystal display, comprising:
a first substrate and a second substrate, and liquid crystal molecules interposed between the first and second substrates;
a plurality of data lines arranged on the second substrate;
an insulation layer arranged on the data lines; and
a plurality of common electrodes arranged on the insulation layer, some or all of the common electrodes essentially aligned with the corresponding data lines, respectively, while substantially extending in a non-linear manner.

20. The liquid crystal display as claimed in claim 19, wherein said some of all of the common electrodes occupy more vertical dimension in comparison with a linear horizontally extending common electrode.
